(19) United States
(12) Patent Application Publication
(10) Pub. No.: US 2014/0236784 A1
(43) Pub. Date: Aug. 21, 2014

(54) SHIPPING ORDER SETTLEMENT BASIS

(71) Applicants: Ajay Narasimha Murthy, Bangalore (IN); Murugesh Karunamurthy, Bangalore (IN)

(72) Inventors: Ajay Narasimha Murthy, Bangalore (IN); Murugesh Karunamurthy, Bangalore (IN)

(73) Assignee: SAP AG, Walldorf (DE)

(21) Appl. No.: 13/769,579

(22) Filed: Feb. 18, 2013

(51) Int. Cl. G06Q 30/04

(52) U.S. Cl. CPC G06Q 30/04; G06Q 10/083
USPC 705/34

(57) ABSTRACT

A system receives an order for a shipment of goods, and extracts data from the order for use in creating a bill for the shipment. The system creates a settlement basis map using the data extracted from the order and an agreement between the producer of the goods and a logistics service provider. Settlement bases for the bill are then determined. The settlement bases include an order basis and/or an execution basis. The system prepares billable data for the bill based on the settlement bases. The system updates the order by discarding the stages of the order that are to be billed based on the execution basis. The system then formulates the execution data, consolidates any remaining order data and the execution data, and creates the bill for the shipment based on the settlement bases, the order data, and the execution data.

### TECHNICAL FIELD

The present disclosure relates to a system and method for settlement bases for shipping orders.

### BACKGROUND

A producer of goods has to move its finished goods through one or more distribution channels to its customers who purchase the goods. If the producer contracts with a transportation company to deliver its goods, then the transportation company delivers the goods and bills the producer (i.e., the customer of the transportation company) for the delivery of the goods. Such transportation companies can be referred to as logistics service providers (LSP). Even in instances where the producer has its own delivery system and vehicles, in many instances, for accounting purposes, the delivery and logistics portions of the business must keep track of the cost of delivering the goods and bill (or at least account for) the cost of the delivery of the goods to other departments of the business organization.

Typically, a producer of goods transmits a forwarding order (i.e., a transportation service request for the producer's goods) to a freight forwarder (i.e., the logistics service provider (LSP)). The logistics service provider creates a forwarding order (FWO) in its system. To commence the billing process for any such forwarding order, the billing system typically creates a forwarding settlement document (FWSD, i.e., a settlement document that is sent to the customer). In this process, items or goods that are billed and that are part of the settlement documents are the forwarding orders originally placed by the producer. The typical settlement scenario can be referred to in the industry as order based settlement.

### BRIEF DESCRIPTION OF THE DRAWINGS

FIG. 1 is a block diagram of a system for creating billings and billing documents for the shipment of goods.

FIG. 2 is a block diagram of the settlement basis module of FIG. 1.

FIGS. 3A and 3B are a flowchart-like diagram illustrating steps and features of a system and method for creating billings and billing documents for the shipment of goods.

FIG. 4 is a block diagram of an example embodiment of a computer processor system upon which one or more embodiments of the present disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

One or more embodiments of the present disclosure offer an alternative to the typical order based billing systems currently used by logistic service providers. Specifically, there are different producer-logistical service provider relationships, scenarios, and variants that exist in business and industry, and the embodiments disclosed herein address those scenarios and variants. For example, in road and trucking transportation, there could be several different ways in which the producers of the goods are billed by a logistics service provider.

As noted above, in the past, a shipment of goods was normally only billed in one way based on the order. That is, each order or forwarding order submitted by a producer of goods was individually billed at a single, flat rate price for that one order, Now, as in the one or more embodiments disclosed herein, billing can be based on sets of consolidated orders, and further based on segmented portions of an order. These sets of consolidated orders are not merely a collection of individual bills. Rather, these sets are based on the particular manner in which the shipments are consolidated and the manner is which routes are optimized, for example. Consequently, if a logistics service provider determines that a particular shipment of goods is best shipped along a route with an intermediate stop or two, and not just on a trailer that goes directly from a source to a destination, then one or more embodiments provide a flexible billing means to handle such decisions by the logistics service provider. With an embodiment then, a choice of a settlement basis gives a logistics service provider an entry point in the system to specify what type of billing is required—i.e., either order based, execution based, or a combination of order based and execution based.

For example, in the past, as logistics service provider may have received ten individual forwarding orders to ship ten individual items, each item weighing 100 kg, and may have charged $100 for each item for a total of $1000. With one or more of the herein disclosed embodiments however, the logistics service provider is now capable of placing those separate items on a single trailer, and furthermore is capable of generating a billing reflecting that logistical decision, by billing for example $800 for the 1,000 kg. Such a determination by the logistics service provider can be based on execution data (such as the service level associated with the provider, the stage category (pick up, main carriage, etc.)) in the order, and an agreement with the customer. Simply put, the billing follows the lead of the logistical decisions of the logistic service provider. The billing does not dictate the logistical decisions of the logistic service provider or hamstring the logistics service provider. Consequently, when the logistics service provider determines that at least part of a shipment is to be billed on an execution basis, the shipment is segmented into different stages, and each stage has a settlement basis (either order-billed or execution-billed). Then, as discussed in detail below, several intermediate steps are executed, and then a bill is generated for the entire order based on the settlement basis for each stage, and further based on order data if it is an order based settlement for a particular stage or execution data if it is an execution-based settlement for a particular stage. In other words, the settlement creation respects the agreement between the producer/customer and the logistics service provider such that the billing system creates either an order based settlement/invoice or an execution based invoice for a particular stage.

In an embodiment, a logistics service provider has a long term contract with the producer of goods. This contract relates to the management of the logistics of the goods. In this scenario, the logistics service provider has a dedicated fleet for such producers. In such cases, as noted above, producers of goods are always charged a flat rate for leasing out the vehicles. Consequently. the only additional factor in determining how to bill the producer of goods is the manner in which the logistics service provider executes the movement of goods from the source location to the destination location. In such cases, the logistics service provider can consolidate multiple orders into a single execution unit, and then ship the goods. As a result, it becomes necessary to bill the producer based on execution documents. That is, the logistics service provider, if it can, handles the movement of the producer's goods using a single trailer or truck. Additionally, in this scenario, the logistics service provider could load the goods of two or more producers of goods on the single truck or trailer.

In an embodiment, the billing of the providers of goods in such a scenario is based on execution data such as the distance travelled, the type of vehicle used for transportation, the type of trailer used, and other resources used to transport the goods. More specifically, the billing unit could be an execution unit (that is, a resource used to transport the goods) like a trailer. Alternatively, the billing unit could be trip-based, that is, each execution step is one billing line for the billing of the producer to deliver its goods in a particular forwarding order. This type of settlement basis is referred to as an execution based settlement.

In a logistics billing system having combined order based and execution based billing capabilities, there are two primary documents. There is a customer order/forwarding document that is received from a customer (producer of the goods), and an execution order document. An embodiment permits a logistics service provider to decide how to handle, process, and execute multiple customer orders in an optimal way. Such decisions by a logistics service provider can involve consolidation of an order, route optimization, and other techniques. After such decisions are made regarding one or more customer orders, the execution order document is created.

In making such decisions, the logistics service provider treats a trailer as the passive vehicle that it is. The trailer needs an active vehicle (i.e., truck/cab) to pull the trailer. The truck can have a goods capacity of its own, such as when a cargo hold is attached to the truck, and such a truck/cargo hold type vehicle can also pull a trailer. More specifically, in the process of moving the traders, a logistics service provider could decide to use more than one active vehicle (truck) (e.g., a first truck that transports a first trailer from location A to location B (a route/trip), and a second truck that transports the first trailer from location B to location C (another route/trip)). The logistics service provider could consolidate the producer-customer's shipments into a trailer and then bill the customer based on the number of trailers that were used to transport the goods (i.e., order based). Alternatively, the logistics service provider could bill the customer based on the number of routes/trips that it made to move the trailer from the source (e.g., location A) to the destination (e.g., location B) (i.e., execution based). Additionally in an embodiment, the logistics service provided could bill the customer based on the number of trailers to transport the goods over a first portion of the shipment, and then bill the customer based on the number of routes/trips that it made to move the trailer from a first location in the shipment to a second location in the shipment (i.e., a combination of order based and execution based).

In an embodiment, a trailer (also referred to as a planning document) and a trip also known as an execution document) are modeled and maintained as separate documents in the logistic service provider's system. An execution document can consolidate multiple order documents via efficient planning modules within the system. The trigger of the creation of a billing document can occur from any one of the customer orders, after the settlement basis is determined. For example, if it is execution based, there first is a look up for all the other customer order parts of the execution document, a validation or determination if they all are execution based, and if they are all execution based, a collective bill is created for the customer for all of the customer's orders.

As indicated above, a logistic service provider's billing capabilities are typically built around customer billing (forward servicing document (FWSD))) that use the forwarding orders (FWOs) as the basis of billing. As further noted above, the forwarding orders are not necessarily sufficient enough to do the customer billing as execution based as indicated in the above example. That is the forwarding order does not include the trailer since there could be multiple forwarding orders that are on the trailer and this eventually becomes the combined basis for the billing. Hence, the need to identify these billing patterns to create billable items is achieved via the settlement basis. The settlement basis for the customer is captured in an agreement between the customer and the logistics service provider that is set up in the system for that customer. The trigger of FWSD creation is always from the forwarding order, thereby establishing the relationship between the ordered route (stages in the forwarding order) and the executed route (actual route by which the forwarding order items were transported). This can be important in terms of building the execution data and modifying the order data as the execution and order data are important in terms of charge calculation.

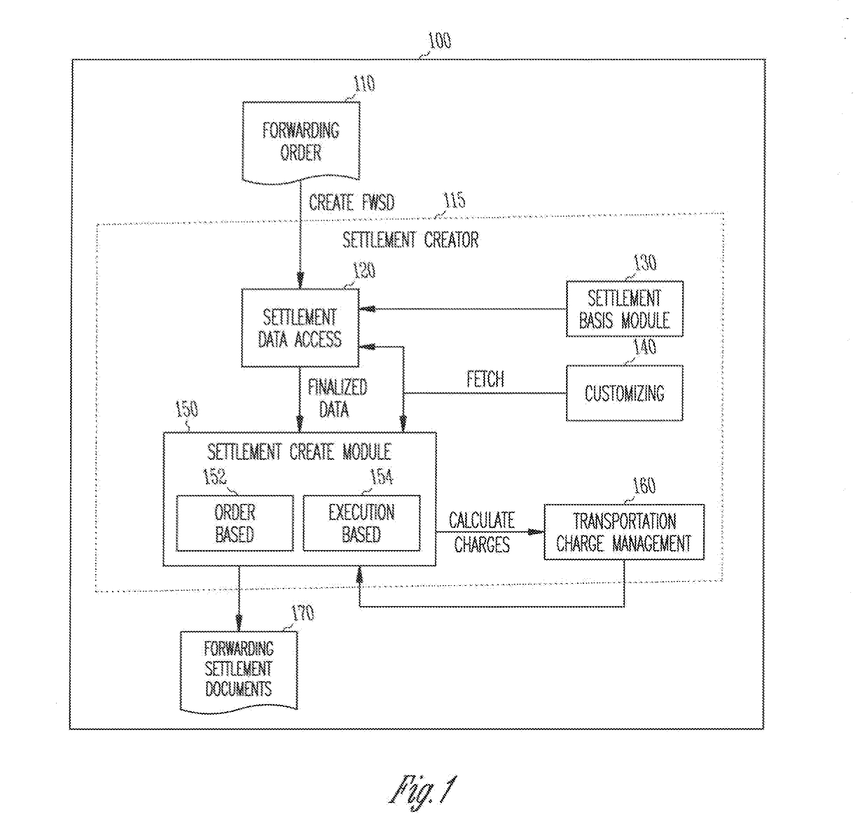

FIG. 1 is a block diagram of a system 100 for creating billings and billing documents for the delivery of goods. From the forwarding order 110, created for the shipment of goods of the producer-customer, control is passed on to the settlement creator 115. The logistical data relevant for billing shipment prepared which captured in the settlement data access block 120. Settlement data access 120 coordinates with the settlement basis module 130. The settlement basis module 130 evaluates the basis of billing (i.e., order or execution), and prepares the data (once again, order based data or execution based data), and provides the finalized data back to settlement data access 120, which in turn feeds it to the settlement create module 150. The settlement create module 150 includes an order based module 152 and an execution based module 154. The settlement create module 150, based on the type of data which is available, decides the basis for the billable items. If the data from settlement data access 120 is execution based, it would create the billable item as, for example, a trailer, which as noted above is the execution based entity against which the customer is charged. The settlement create module 150 collaborates with the transportation charge management module 160 and creates appropriate charges for the billable item created.

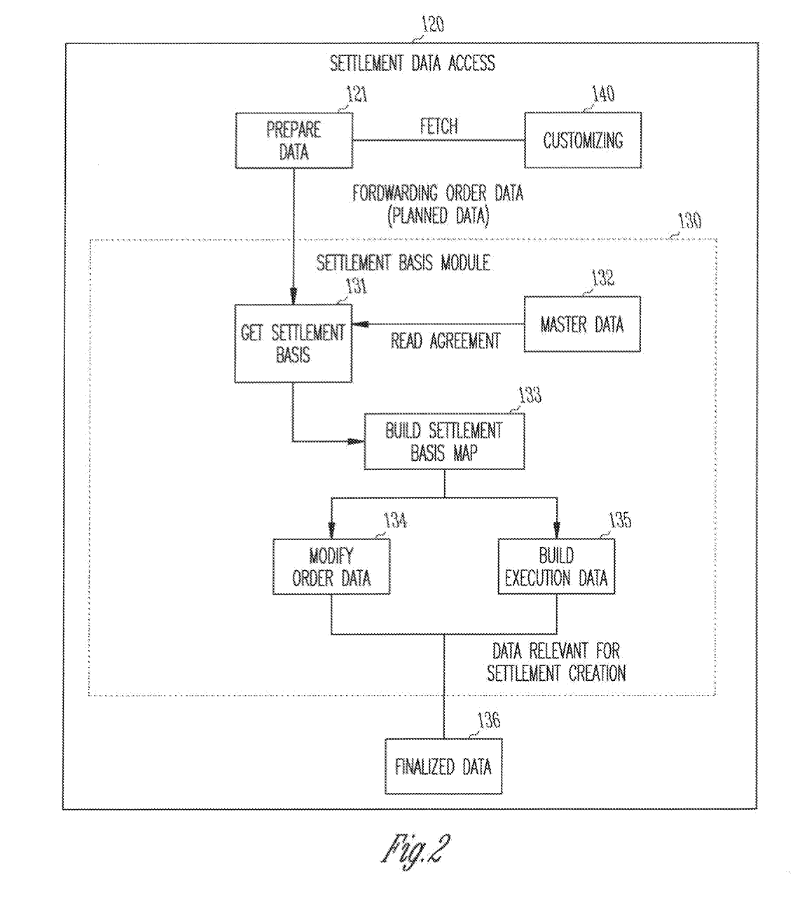

A more detailed analysis of the collaboration between the settlement data access module 120 and the settlement basis module 130 is depicted in FIG. 2. On trigger of creation of forwarding settlement document 170 from the forwarding order, the data relevant for settlement creation is prepared in an initial phase. In settlement data access 120, the forwarding order data 110 that are pertinent to billing are fetched. This data can be customized at 140. Specifically, an FWO can have planned data and actual data. For example, an order is placed for transporting 100 kg or goods. However, when the logistics service provider picked up the goods from the customer, there were actually 105 kg. In an order based settlement, flexibility is needed to decide which data (planned or actual) needs to be used for pricing. This is part of the customization. The forwarding order data 110 that is prepared at 121 is then passed onto the settlement basis module 130. In the settlement basis module 130, the settlement basis 131 for that customer is determined by accessing the transportation charge management (TCM) master data 132. The settlement basis 131 is captured in the agreement setup for the customer.

For example, a forwarding order 110 could be created for movement of goods from location A to location C. The logistics service provider determines, based on many factors such as other shipments for other customers and the trailers used for and the destinations of those other shipments, that the forwarding order 110 will travel from location A to location B and then from location B to location C. In such a case, location B is the intermediate locution and location C is the final destination. The forwarding order 110 can then be consolidated in a trailer either with or without other forwarding orders 110 of the same customer and/or different customers. Irrespective of whether the shipments of other customers are involved, the entire consignment is executed in a trailer.

With the settlement basis determined for a customer, a mapping table 133 is created that maps the stage of the trailer document to the stage of the forwarding order and the settlement basis for the same. Once the settlement basis map table 133 is constructed, the forwarding order data is updated by discarding the stages of the forwarding order (134) that are to be billed via execution data (135) of that stage, the execution data being available in the trailer document based on the entry in the mapping table. Further, the execution data is formulated, and both of the datasets (134, 135) are consolidated to get a finalized data 136 that is used for the billing of a particular forwarding order.

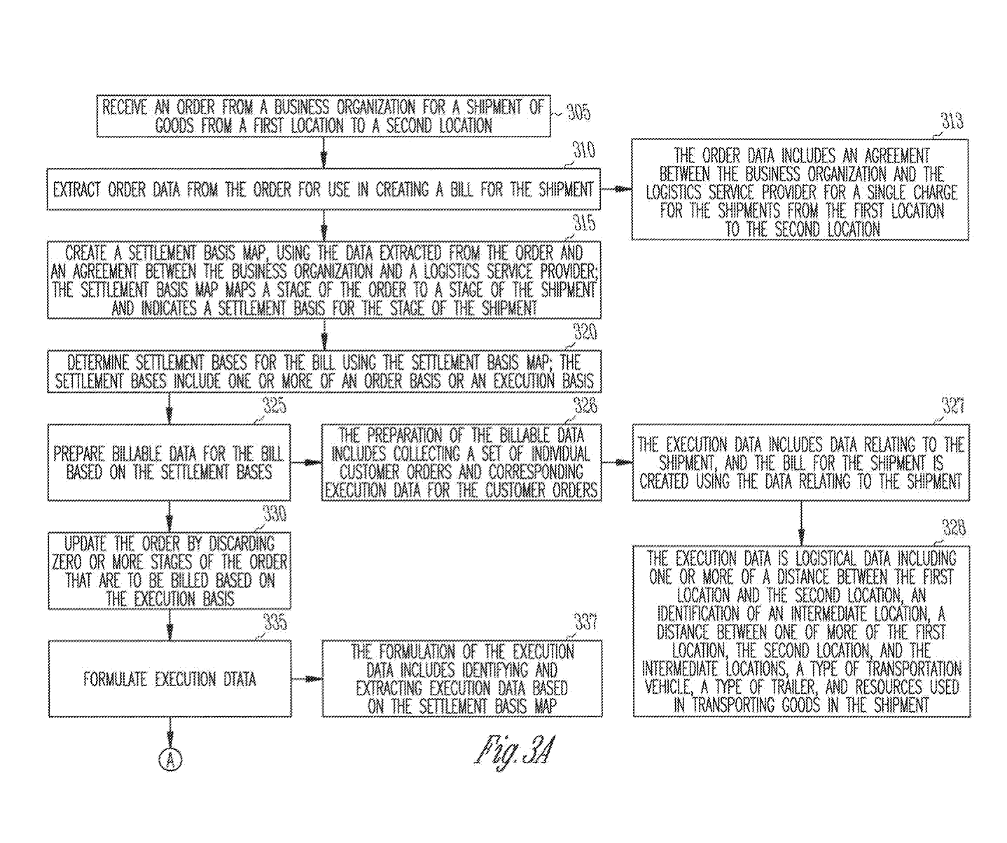

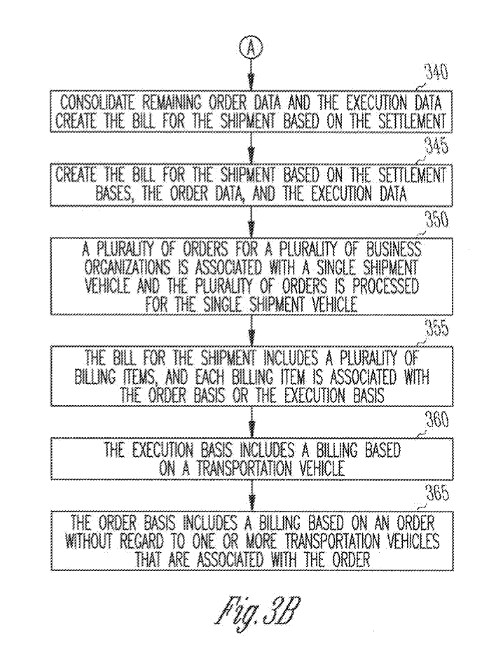

FIGS. 3A and 3B are a flowchart-like diagram of features and steps of an example process 300 for logistical settlement. FIGS. 3A and 3B include a number of process blocks 305-365. Though arranged serially in the example of FIGS. 3A and 3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 3A and 3B, at 305, a settlement basis billing system having order based and execution based settlement capabilities receives an order (forwarding order) from a business organization for a shipment of goods from a first location to a second location. At 310, the system extracts order data from the order for use in creating to bill for the shipment. As noted above and at 313, the order data can include an agreement between the business organization and the logistics service provider for a single charge for the shipments from the first location to the second location. That is, a single charge for a particular item or group of items irrespective of the trailer used, the number of intermediate stops for the shipment, and other factors.

At 315, the system creates a settlement basis map. In creating the settlement basis map, the system uses the data extracted from the order and an agreement between the business organization and a logistics service provider. The settlement basis map maps a stage of the order to a stage of the shipment and indicates a settlement basis for the stage of the shipment. In this manner, as disclosed herein, the system can use either order based or execution based billing for different stages of a shipment (rather than just order based for the entire shipment). At 320, the system determines settlement bases for the bill using the settlement basis map. As just noted, the settlement bases include an order basis or an execution basis. At 325, the system prepares billable data for the bill based on the settlement bases. As noted at 326, the preparation of the billable data can include collecting a set of individual customer orders (forwarding orders) and the corresponding execution data for the customer orders. Block 327 discloses that the execution data can include data relating to the shipment. When the billing is execution based, the bill for the shipment is created using the data relating to the shipment. More specifically, as indicated at 328, the execution data is logistical data that can include a distance between as source location of the goods and the destination location of the goods, art identification of intermediate locations in the transport of the goods, a distance between one of more of the first location, the second location, and the intermediate locations, a type of transportation vehicle (e.g., a truck with or without an attached cargo hold), a type of trailer, and resources used in transporting goods in the shipment.

At 330, the customer order is updated by discarding stages of the order that are to be billed based on the execution basis. If the entire customer order is to be billed based on an order basis, then no stages from the customer order will be discarded. At 335, for the stages that are to be billed based on an execution basis, the system formulates execution data. As noted at 337, the formulation of the execution data can include identifying and extracting execution data based on the settlement basis map. At 340, the system consolidates the remaining order data (that is, order data that has not been discarded because its corresponding stage is order based, not execution based) and the execution data. At 345, the system creates the bill for the shipment based on the settlement bases from the settlement basis map), the order data (for stages of the order to be order based), and the execution data (for stages of the order to be execution based).

At 350, a plurality of orders for a plurality of business organizations is associated with a single shipment vehicle and the plurality of orders is processed for the single shipment vehicle. That is, a vehicle can transport the shipment orders of more than one customer, and the system can bill each of those customers separately—either order based or execution based. At 355, the bill for the shipment includes a plurality of billing items, and each billing item is associated with the order basis or the execution basis. At 360, the execution basis includes a billing based on a transportation vehicle. At 365, the order basis includes a billing based on an order without regard to one or more transportation vehicles that are associated with the order.

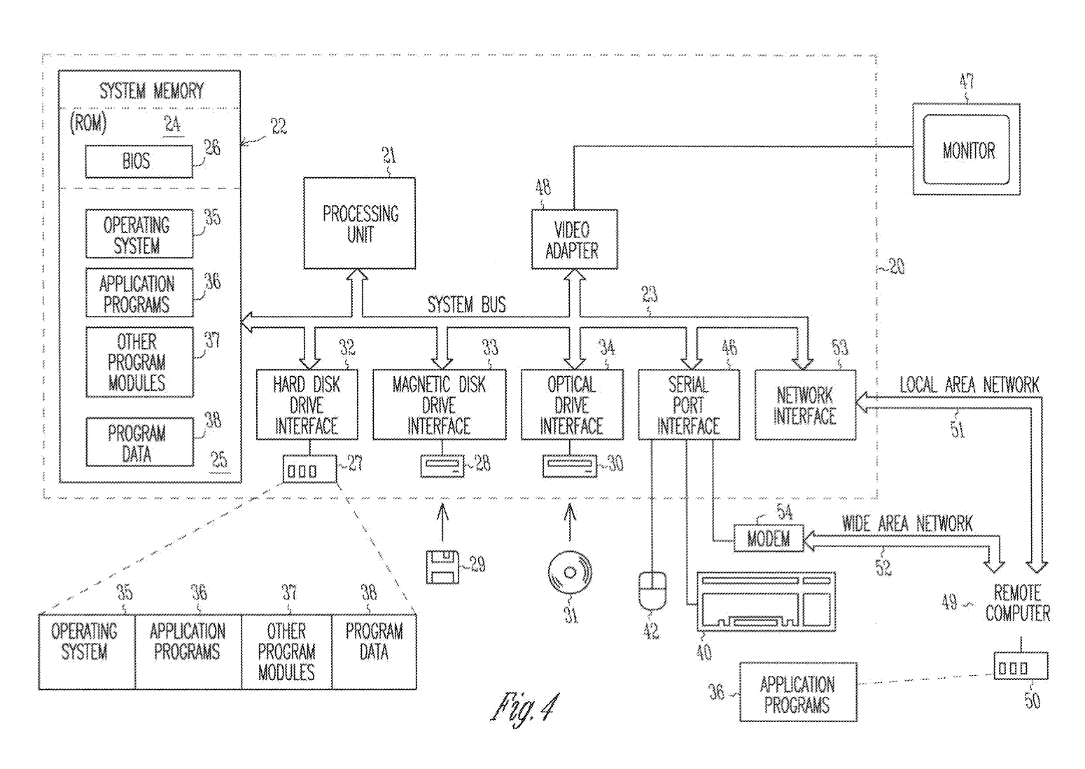

FIG. 4 is an overview diagram of hardware and an operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment, A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, as network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, 1-T3 lines, DSL's. OC-3 and/or OC-12, TCP/IP, microwave, wireless application protocol, and any other electronic media through any suitable switches, routers, outlets and power lines, as the same are known and understood by one of ordinary skill in the art.

Thus, an example system, method and machine readable medium for using software neural networks for determining relationships among software objects have been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor and a computer storage device operable to manage shipments for a plurality of business organizations by:
(1) receiving an order from a business organization for a shipment of goods from a first location to a second location;
(2) extracting order data from the order for use in creating a bill for the shipment;
(3) creating a settlement basis map, using the data extracted from the order and an agreement between the business organization and a logistics service provider, wherein the settlement basis map maps a stage of the order to a stage of the shipment and indicates a settlement basis for the stage of the shipment;
(4) determining settlement bases for the bill using the settlement basis map, the settlement bases comprising one or more of an order basis or an execution basis;
(5) preparing billable data for the bill based on the settlement bases;
(6) updating the order by discarding zero or more stages of the order that are to be billed based on the execution basis;
(7) formulating execution data;
(8) consolidating remaining order data and the execution data; and
(9) creating the bill for the shipment based on the settlement bases, the order data, and the execution data.

2. The system of claim 1, wherein the order data comprises an agreement between the business organization and the logistics service provider for a single charge for the shipments from the first location to the second location.

3. The system of claim 1, wherein the execution data comprises data relating to the shipment, and the bill for the shipment is created using the data relating to the shipment.

4. The system of claim 3, wherein the execution data comprise logistical data including one or more of a distance between the first location the second location, an identification of an intermediate location, a distance between one or more of the first location, the second location, and the intermediate locations, a type of transportation vehicle, a type of trailer, and resources used in transporting goods in the shipment.

5. The system of claim 1, wherein the preparing the billable data comprises collecting a set of individual customer orders and corresponding execution data for the customer orders.

6. The system of claim 1, wherein the formulating the execution data comprises identifying and extracting execution data based on the settlement basis map.

7. The system of claim 1, wherein a plurality of orders for a plurality of business organizations is associated with a single shipment vehicle and the plurality of orders is processed for the single shipment vehicle.

8. The system of claim 1, wherein the bill for the shipment comprises a plurality of billing items, and wherein each billing item is associated with the order basis or the execution basis.

9. The system of claim 1, wherein the execution basis comprises a billing based on a transportation vehicle.

10. The system of claim 1, wherein the order basis comprises a billing based on an order without regard to one or more transportation vehicles that are associated with the order.

11. A process comprising:
(1) receiving an order from a business organization for a shipment of goods from a first location to a second location,
(2) extracting order data from the order for use in creating a bill for the shipment;
(3) creating a settlement basis map, using the data extracted from the order and an agreement between the business organization and a logistics service provider, wherein the settlement basis map maps a stage of the order to a stage of the shipment and indicates a settlement basis for the stage of the shipment;
(4) determining settlement bases for the bill using the settlement basis map, the settlement bases comprising one or more of an order basis or an execution basis;
(5) preparing billable data for the bill based on the settlement bases;
(6) updating the order by discarding zero or more stages of the order that are to be billed based on the execution basis;
(7) formulating execution data;
(8) consolidating remaining order data and the execution data; and
(9) creating the bill for the shipment based on the settlement bases, the order data, and the execution data.

12. The process of claim 11, wherein the order data comprises an agreement between the business organization and the logistics service provider for a single charge for the shipments from the first location to the second location.

13. The process of claim 11, wherein the execution data comprises data relating to the shipment, and the bill for the shipment is created using the data relating to the shipment.

14. The process of claim 13, wherein the execution data comprise logistical data including one or more of a distance between the first location and the second location, an identification of an intermediate location, a distance between one or more of the first location, the second location, and the intermediate locations, a type of transportation vehicle, a type of trailer, and resources used in transporting goods in the shipment.

15. The process of claim 11, wherein the preparing the billable data comprises collecting a set of individual customer orders and corresponding execution data for the customer orders.

16. The process of claim 11, wherein the formulating the execution data comprises identifying and extracting execution data based on the settlement basis map.

17. The process of claim 11, wherein a plurality of orders for a plurality of business organizations is associated with a single shipment vehicle and the plurality of orders is processed for the single shipment vehicles.

18. The process of claim 11, wherein the bill for the shipment comprises a plurality of billing items, and wherein each billing item is associated with the order basis or the execution basis.

19. The process of claim 11, wherein the execution basis comprises a billing based on a transportation vehicle; and wherein the order basis comprises a billing based on an order without regard to one or more transportation vehicles that are associated with the order.

20. A computer readable storage device comprising instructions that when executed by a processor execute a process comprising:
(1) receiving an order from a business organization for a shipment of goods from a first location to a second location;
(2) extracting order data from the order for use in creating a bill for the shipment;
(3) creating a settlement basis map, using the data extracted from the order and an agreement between the business organization and a logistics service provider, wherein the settlement basis map maps a stage of the order to a stage of the shipment and indicates a settlement basis for the stage of the shipment;
(4) determining settlement bases for the bill using the settlement basis map, the settlement bases comprising one or more of an order basis or an execution basis;
(5) preparing billable data for the bill based on the settlement bases;
(6) updating the order by discarding zero or more stages of the order that are to be billed based on the execution basis;
(7) formulating execution data;
(8) consolidating remaining order data and the execution data; and
(9) creating the bill for the shipment based on the settlement bases, the order data, and the execution data.
